(19) United States
(12) Patent Application Publication
(10) Pub. No.: US 2007/0148293 A1
(43) Pub. Date: Jun. 28, 2007

(54) Packaged consumable products with user-selectable aromas

(75) Inventors: Jeffrey Dean Lindsay, Appleton, WI (US); Jennifer L. Marvin, Everett, WA (US); Daphne Lynn VanBuren, Greenville, WI (US); Fung-Jou Chen, Appleton, WI (US); Frank Gerald Druecke, Oshokosh, WI (US); James J. Tanner, Athens, GA (US); Kenneth W. Bester JR., Appleton, WI (US); Teresa M. Zander, Bonduel, WI (US)

Correspondence Address: DORITY & MANNING, P.A., POST OFFICE BOX 1449, GREENVILLE, SC, 29602-1449, US

(73) Assignee: Kimberly-Clark Worldwide, Inc.

(21) Appl. No.: 11/319,035

(22) Filed: Dec. 27, 2005

(51) Int. Cl. A21D 10/02

(52) U.S. Cl. 426/112

(57) ABSTRACT

An aroma delivery device is disclosed that may be packaged with a consumable product or used to provide a scent to a consumable product at the point purchase. In one embodiment, the aroma delivery device includes a plurality of user-selectable aroma elements. Each aroma element may possess a different scent. When the aroma delivery device is packaged with a consumable product, a user can then select one of the aroma elements for providing a scent either to the product or to the environment in which the product is to be used. The consumable product, for instance, may comprise a personal hygiene product or a tissue product. In an alternative embodiment, an aroma delivery device may be configured to inject a scent into a consumable product at the point of purchase.

### BACKGROUND OF THE INVENTION

Aroma generators, such as air fresheners, represent a significant commercial market. Air fresheners are intended, for instance, to slowly or quickly release a fragrance into the atmosphere in order to avoid or mask unpleasant odors. Air fresheners are sold in all different types, forms and sizes. Examples of air fresheners include candles, scented potpourri, liquid sprays, and the like. Other examples of air fresheners include devices that contain a gel-like matrix containing one or more fragrance components. In some embodiments, these devices are intended to be plugged into an outlet to assist in releasing a scent.

Still another embodiment of an odor producing device is disclosed in U.S. Pat. No. 4,556,539. In the '539 patent, a disc-playing aroma generator is disclosed in which a disc is inserted into a player causing an aromatic vapor to be discharged into the atmosphere. In one embodiment, a user can select from a library of aromatic discs for filling a room with a pleasing or mood-modifying aroma.

Although various different types of air fresheners are known in the art, a need exists for incorporating air fresheners and other aroma delivery devices in combination with consumable products. Consumable products, as used herein, generally refer to products that are regularly purchased and replaced by consumers. Consumable products may include, for instance, tissue products such as bath tissue and facial tissue, personal hygiene products, diapers and related auxiliary products, paper towels, and the like.

More particularly, a need currently exists for an aroma delivery device that can be packaged with a consumable product for either dispensing an aroma into an environment in which the consumable product is used or for dispensing an aroma into the product itself. A need also exists for an aroma delivery device that may be packaged with the consumable product, and includes multiple aromas that can be individually selected by the consumer.

### SUMMARY OF THE INVENTION

The present disclosure is generally directed to consumable products that may be packaged with an aroma delivery device. The aroma delivery device can be used for providing a scent to the product itself or for providing a scent into an environment in which the product is used. In one embodiment, the aroma delivery device can include user-selectable aromas that can be incorporated into the packaging of the product so that a user can select an aroma or scent as desired.

In one particular embodiment, the present disclosure is directed to a packaged product comprising a consumable product and packaging surrounding the consumable product. An aroma delivery device may be contained within the packaging. The aroma delivery device may comprise a plurality of user-selectable aroma elements, each possessing a different scent. The aroma delivery device can be configured such that a user of the consumable product can select and activate at least one of the aroma elements for releasing a scent into the consumable product or into an environment where the consumable product is located.

In one embodiment, for instance, the aroma delivery device may comprise a substrate upon which the aroma elements are located. The aroma delivery device may further include a cover positioned over the substrate. The cover may be moveable with respect to the substrate for selectively exposing one or more of the aroma elements. For instance, in one particular embodiment, the substrate may be in the shape of a disc and the aroma elements may have a triangular shape equally spaced around the disc. The cover may be moveable with respect to the disc for exposing one of the aroma elements through an opening.

The aroma delivery device may include a plurality of aroma elements, such as at least two aroma elements, such as at least three aroma elements, such at least five aroma elements, or such as least eight aroma elements. In one embodiment, different aroma elements may be combined for producing still other scents.

The consumable product packaged with the aroma delivery device may vary depending upon the particular application and the desired results. In one embodiment, for instance, the consumable product may comprise facial tissues that are contained within a dispenser. The aroma delivery device may be attached to an outside surface or to an inside surface of the dispenser, or may be unattached but located within the dispenser or packaging for the product or attached to the product inside the dispenser or packaging. In another embodiment, the consumable product may comprise pre-moistened wipes contained within a dispenser. The aroma delivery device may be attached to an outside surface of the dispenser for releasing an aroma into the air. Alternatively, the aroma delivery device may be attached to the inside surface of the dispenser for releasing an aroma when the dispenser is opened or for delivering a scent directly to the product. The aroma may be released into the air directly or may first diffuse or flow into the product to give it a scent.

In still other embodiments of the present invention, the consumable product may comprise a feminine care product, an adult incontinence product, a training pant, or a diaper. In these embodiments, the aroma delivery device may be configured to be attached directly to the product or may be configured to dispense an aroma element into the product.

In still another embodiment, the aroma delivery device may comprise a substrate upon which the aroma elements are located. Each of the aroma elements may be individually sealed by an odor impervious covering that can be removed by the user to expose the underlying aroma element. In still another embodiment, the aroma delivery device may comprise a plurality of sealed pouches. Each sealed pouch may include a frangible seal for opening the pouch and exposing an aroma element. Examples of systems employing frangible seals that can be adapted for the delivery of aromas according to the present invention are disclosed in U.S. Pat. No. 5,616,337, “Unit Dose Skin Care Package,” issued Apr. 1, 1997 to Kasianovitz; U.S. Pat. No. 6,705,541, “Fragrance Dispenser,” issued Mar. 16, 2004 to Schuehrer and Renner; and WO 02/42176A1, “Sample Fluid Product Dispenser,” by Valois et al., published May 30, 2002.

The aroma element may comprise any suitable material or composition capable of releasing an odor or scent. In various embodiments, for instance, the aroma element may comprise micro-capsules containing a fragrance, a wax mixed with a fragrance, activated carbon containing a fragrance, and the like.

In one embodiment, the aroma delivery device may be placed in operative association with a heating device. The heating device can be used to heat one or more of the aroma elements for facilitating release of an aroma into the air. Heat can be delivered by electrical (resistive) heating driven from a power source such as a battery, particularly a thin-film or printed battery such as those of PowerPaper, Inc. (Einat, Israel); exothermic chemical reactions such as the reaction of a magnesium-iron alloy and a salt in the presence of water and confined within a flexible covering as described in U.S. Pat. No. 5,443,056, “Exothermic Heater Device,” issued Aug. 22, 1995 to Smith et al., or other known exothermic systems such as carbon-iron mixtures. Heat may also be delivered by oxidation of a fuel or from electrical power generated by oxidation of a fuel in a fuel cell such as a micro-fuel cell (see, for example, U.S. Pat. No. 6,392,313 issued to Hockaday, incorporated herein by reference).

In another embodiment, the aroma elements of the aroma delivery device comprise string members. Each string member may contain a selected aroma producing composition for emitting a selected aroma. The string members can be attached to the packaging for the consumable product or to the consumable product itself and, when attached to the packaging or the product, can be enclosed by a coating composition that prevents the selected aroma from being released. The coating composition may be friable and configured to form breaches and expose the string member as the string member is pulled incrementally away from the packaging or the product for releasing the selected aroma.

For instance, the coating composition that covers the string members may comprise any suitable resin or adhesive capable of attaching the string member to the packaging or to the product but still allowing release of the selected aroma upon being pulled away from the packaging or product. In one embodiment, the coating composition may comprise a sugar, a starch, or mixtures thereof.

In one particular embodiment, the string members may be attached to the packaging for the consumable product and the packaging may include design elements that coordinate with the selected aroma of the string member. For instance, the packaging may display flowers and/or fruits that match an aroma that is emitted by the string members. In one embodiment, the string members can be integrated into the design elements. For instance, in one embodiment, the string members can be spirally wound together and attached to the packaging so as to form part of the design elements.

In still another embodiment of the present disclosure, the aroma elements of the aroma delivery device comprise peelable substrates stacked together. Each peelable substrate may contain an aroma producing composition for emitting a selected aroma. The peelable substrates are configured to be peeled away from one another for exposing a selected aroma.

For instance, in one embodiment, the substrates may comprise a paper or plastic material that is coated with an adhesive composition containing the aroma producing composition. The aroma producing composition may, for instance, comprise microcapsules that are ruptured when a top layer is peeled away from the aroma element.

In addition to incontinence products and wiping products, the aroma delivery device may be packaged with other types of personal hygiene products. For example, in one embodiment, the aroma delivery device may be packaged with an antiperspirant product or deodorant product. In this embodiment, the product may contain an antiperspirant or deodorant composition that may be treated with an aroma element for providing a scent to the composition. The composition, for example, may comprise a liquid or a solid and the aroma element may comprise a liquid that is applied to the composition.

The aroma delivery device may also be incorporated in disposable or reusable stretchable wraps that can be wrapped around a joint or region of the body with sore muscles to provide support or relief, including thermal wraps with heat sources from exothermic reactions.

The aroma delivery device may also be packaged or associated with cleaning products such as mops, dusters, sponges, wet wipes, disposable towels, and the like.

The aroma delivery device associated with a product may comprise a source of electrical power such as a battery, a think-film or printable battery, or a fuel cell, for heating the aroma. Alternatively, the delivery device may be free of electrical power sources or may not employ electrical power.

In still another embodiment of the present disclosure, a user-selected scent can be incorporated into a consumable product at the point of purchase. In this embodiment, the process includes the steps of selecting a consumable product in a retail store and, at the point of purchase, applying a user-selected aroma composition to the consumable product.

The aroma composition may be applied to the product using an aroma delivery device located within the retail store. The aroma delivery device, for instance, may include a scanner that scans the product to ensure that the correct product category has been loaded into the device. For example, if the aroma delivery device is to be used with a certain brand of facial tissues, the device can scan, for instance, a barcode on the box to ensure that the correct product is being treated. The aroma delivery device can than have some type of injection system for injecting the aroma composition into the product. The aroma delivery device, for instance, may be well suited to providing a scent to facial tissues, bath tissues, paper towels, and the like.

Other features and aspects of the present disclosure are discussed in greater detail below.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a perspective view of one embodiment of a consumable product in combination with an aroma delivery device made in accordance with the present disclosure;

FIG. 2 is a plan view with cutaway portions of the aroma delivery device illustrated in FIG. 1;

FIG. 3 is a perspective view of another embodiment of a consumable product in combination with an aroma delivery device in accordance with the present disclosure;

FIG. 4 is a perspective view of the aroma delivery device illustrated in FIG. 3;

FIG. 5 is a perspective view of another embodiment of an aroma delivery device that may be used in accordance with the present disclosure;

FIGS. 6A, 6B and 6C are perspective views and a plan view of three different embodiments of a feminine hygiene product in combination with an aroma delivery device in accordance with the present disclosure;

FIG. 7 is a perspective view of still another embodiment of a consumable product in combination with an aroma delivery device in accordance with the present disclosure;

FIG. 8 is a perspective view of one embodiment of an antiperspirant or deodorant product made in accordance with the present disclosure;

FIG. 9 is a perspective view of another embodiment of a deodorant or antiperspirant product made in accordance with the present disclosure;

FIG. 10 is a perspective view of still another embodiment of a deodorant or antiperspirant made in accordance with the present disclosure;

FIG. 11 is a perspective view of one embodiment of an aroma delivery device that may be used to apply a scent to a consumable product at a point of purchase of the product;

FIGS. 12A through 12C are perspective views of still another embodiment of an aroma delivery device that may be used in accordance with the present disclosure; and

FIG. 13 is a perspective view of a diaper containing another embodiment of an aroma delivery device in accordance with the present disclosure.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only, and is not intended as limiting the broader aspects of the present invention.

In general, the present disclosure is directed to incorporating an aroma delivery device that contains a plurality of user-selectable aromas into product packaging for consumable products. Incorporating an aroma delivery device as described below adds new functionality to the packaging and increases user control of the benefits provided by the product. The aroma delivery device that is incorporated into the packaging for the consumable product can be configured to emit a user-selected aroma or scent that can be used to either provide a scent to the product itself or to provide a scent to the environment in which the product is used. In one embodiment, the aroma delivery device is configured such that one aroma is selected at a time. In other embodiments, however, two or more aromas may be combined, including a base aroma onto which an additional user-selected aroma may be added.

The teachings of the present disclosure may be used in conjunction with any suitable consumable product. Consumable products that may benefit from the aroma delivery device include, for instance, tissue products such as facial tissues, bath tissues and paper towels. Other products that may be used in combination with the aroma delivery device include diapers and related auxiliary products, feminine hygiene products, adult incontinence products, child training pants, and the like. In still other embodiments, the aroma delivery device may be packaged with other hygiene products such as antiperspirant products and deodorant products.

The aromas that are used can be any suitable aroma known in the art. For example, the aromas may include one or more essential oils. Essential oils are highly odoriferous, liquid components obtained from plant tissue (e.g., flowers, bark, leaves, seeds, roots, etc.), often captured by steam distillation or other processes and typically including a mixture of one or more terpenes, esters, aldehydes, ketones, alcohols, phenols, and/or oxides, for example. Commonly used essential oils include those derived from angelica root, anise, balsam (Peru or other balsams), basil, bay laurel, beeswax, benzoin, bergamot, bois-de-rose, boronia, cajeput, cardamom, carrot seed, cedarwood (Atlas or Virginian), chamomile (German or Roman), cinnamon, citronella, clary sage, clove bud, coriander, cypress, dill, elemi, eucalyptus, fennel, fir needle, frankincense, galbanum, geranium, ginger, grapefruit, helichrysum, hyssop, immortelle, jasmine, juniper berry, kanuka, lavender, lavendin, lemon, lemongrass, lime, linden blossom, mandarin, manuka, marjoram, may chang, myrrh, myrtle, neroli, niaouli, nutmeg, oakmoss, olibanum, orange (bitter or sweet), oregano, palmarosa, parsley, patchouli, pepper, black, peppermint, petitgrain, pine (Scotch, white, or Siberian), ravensara, rose, rosemary, rosewood, sandalwood, spearmint, spikenard, spruce, tagetes, tangerine, tea tree (common, lemon, or New Zealand), thyme, tobacco, tuberose, vanilla, vetiver, violet leaf, yarrow, ylang ylang, and so forth. Further information on essential oils and other herbal extracts that can be considered for use in the present invention are discussed in U.S. Pat. No. 6,280,751, issued Aug. 28, 2001 to Fletcher and Hargreaves and in US 20040071757, published Apr. 15, 2004 by D. Rolf, both of which are herein incorporated by reference.

In addition to essential oils, the fragrances used in the present invention can also include other natural products or extracts such as absolutes, resinoids, resins etc., and synthetic compositions as well as mixtures of synthetic and natural fragrances. Synthetic fragrance components may include, by way of example, hydrocarbons, alcohols, aldehydes, ketones ethers, acids, esters, acetals, ketals, nitrites, phenols, etc. including saturated and unsaturated compounds, aliphatic, alicyclic, heterocyclic and aromatic compounds. Examples of such perfume components are given by D. H. Pybus and C. S. Sell in_{—}The Chemistry of Fragrances (Springer Verlag, 1999).

In one embodiment, the fragrance has additional functionality such as serving as an antimicrobial composition. Examples of antimicrobial fragrance compositions are disclosed, for example, in U.S. Pat. No. 6,479,456, “Antimicrobial Perfume Compositions,” issued Nov. 12, 2002 to Holzner, herein incorporated by reference. Other examples can be found in EPA 10451889, EPA 10433132, WO 93/25185, and WO 98/02044. Such fragrances may exhibit an antimicrobial activity of at least 80% as measured by the “agar surface coating test” (ASCT) of Holzner (U.S. Pat. No. 6,479,456).

To enhance the life of the aroma provided, a fragrance can be combined with a stabilizer to provide sustained release over a prolonged period of time. Examples of stabilizers and related controlled release methods are discussed in U.S. Pat. No. 6,172,037, “Perfume Fixatives Comprising Polyvinylpyrrolidone and Hydroxypropyl Cellulose,” issued Jan. 9, 2001 to Perring et al., herein incorporated by reference.

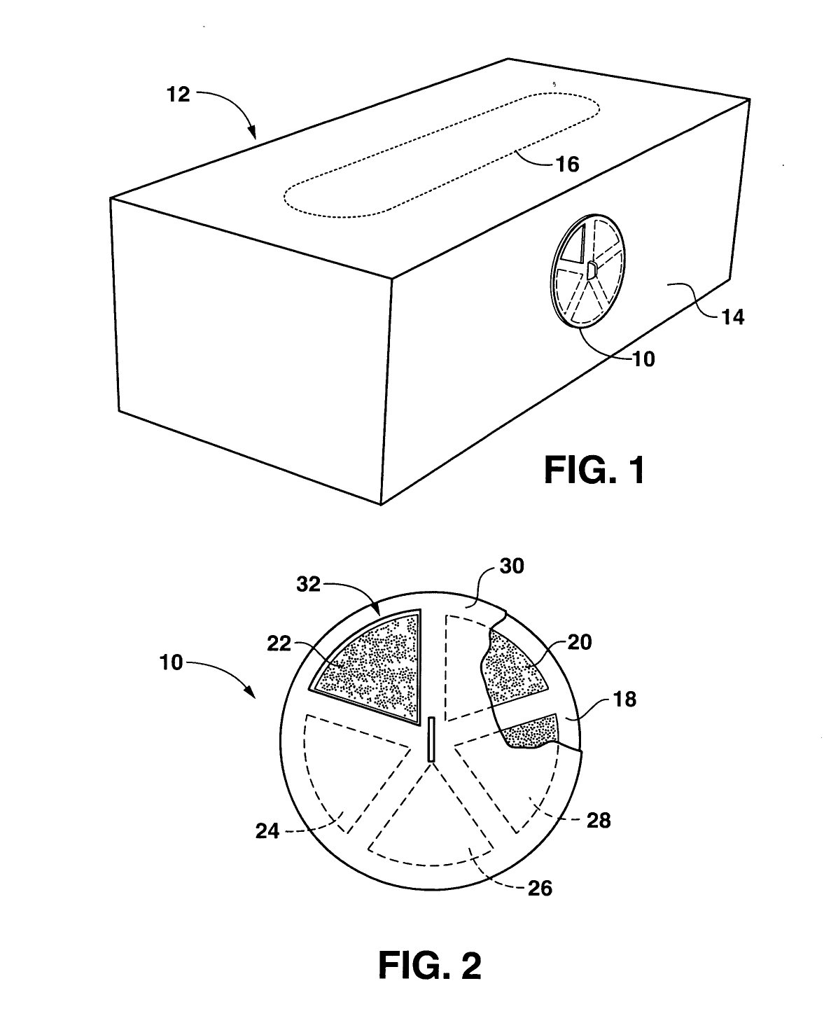

Referring to FIG. 1, one embodiment of an aroma delivery device 10 in combination with a consumable product 12 is illustrated. In this embodiment, the consumable product comprises a stack of facial tissues. The facial tissues are contained within a dispenser 14. As shown, the dispenser 14 includes a perforated panel 16 that may be removed from the dispenser for exposing the facial tissues contained within the dispenser. In this embodiment, the aroma delivery device 10 is mounted on an outside surface of the dispenser 14 for providing an aroma or scent to the environment in which the facial tissues are used. It should be understood, however, that in other embodiments the aroma delivery device 10 may be mounted on an inside surface of the dispenser 14.

Referring to FIG. 2, the aroma delivery device 10 is shown in more detail. The aroma delivery device 10 includes, in this embodiment, a substrate 18 that contains a plurality of aroma elements. Specifically, the substrate 18 is in the shape of a disc containing five triangular-shaped aroma elements 20, 22, 24, 26 and 28. In accordance with the present disclosure, each aroma element is intended to emit a different scent. Further, if desired, one of the aroma elements may be configured to be odorless.

The aroma delivery device 10 further includes an outer cover 30 that defines an opening 32. The outer cover 30 is moveable in relation to the substrate 18 (or alternatively, wherein the substrate is moveable with respect to the outer cover 30). The range of possible movement may include rotation about an axis, linear translation (e.g., laterally sliding), or more complex motions. The outer cover 30 may be made from an odor impervious material, such as a plastic, that shields the aroma elements and prevents the aroma elements from emitting a scent except for the aroma element positioned under the opening 32.

When initially packaged with the consumable product 12, the opening 32 can be covered by any suitable material. For instance, a plastic film, such as a foil tape, may be placed over the opening 32 and include a tab for removing the film and activating the device. Once the film is removed, the user may rotate the disc-like substrate 18 or the outer cover 30 until the user-selected aroma element is positioned below the opening 32. Once positioned below the opening 32, the aroma element is exposed and may emit a scent into the air.

In some cases, an additional step may be needed to activate the aroma (e.g., to permit its release). The may entail removing a protective peel strip, rupturing a sealed pocket of fragrance, applying heat or light, wetting the material (e.g., to release fragrance bound within a cyclodextrin or zeolite), etc.

The scents that can be included in the aroma delivery device 10 can vary depending upon the particular embodiment and the desired result. The aroma elements, for instance, can emit a fragrance of a particular flower or group of flowers, a fragrance of a particular fruit or a combination of fruits, a fragrance of a particular spice, and the like. In this regard, the aroma elements 20, 22, 24, 26 and 28 can be made from any suitable aroma producing composition. For exemplary purposes only, for instance, the aroma elements may comprise microcapsules containing a fragrance, a wax mixed with a fragrance, zeolites, cyclodextrins, or activated carbon containing a fragrance.

In still another embodiment, the aroma element may be configured to release scents associated with aroma therapy. For instance, the aroma element may be configured to emit a eucalyptus scent, a chocolate scent, or the scent of herbs or flowers.

The disc-like substrate 18 can be made from any suitable material capable of accepting an aroma element. In one embodiment, for instance, the substrate 18 may comprise paper, such as a paperboard. The aroma elements 20, 22, 24, 26 and 28 may be applied to a surface of the substrate 18 or may be impregnated into the substrate.

As shown in FIG. 1, the aroma delivery device is mounted on the outside surface of the dispenser 14. In general, the aroma delivery device 10 can be adhered to the outside surface using double-sided tape or an adhesive material. Alternatively, a mechanical attachment device may be used to mount the aroma delivery device 10 to the dispenser 14. In still another embodiment, the wall of the dispenser 14 may actually serve as the substrate 18 as shown in FIG. 2. In this embodiment, for instance, the aroma elements may be printed onto the wall of the dispenser and then covered by the outer cover 30.

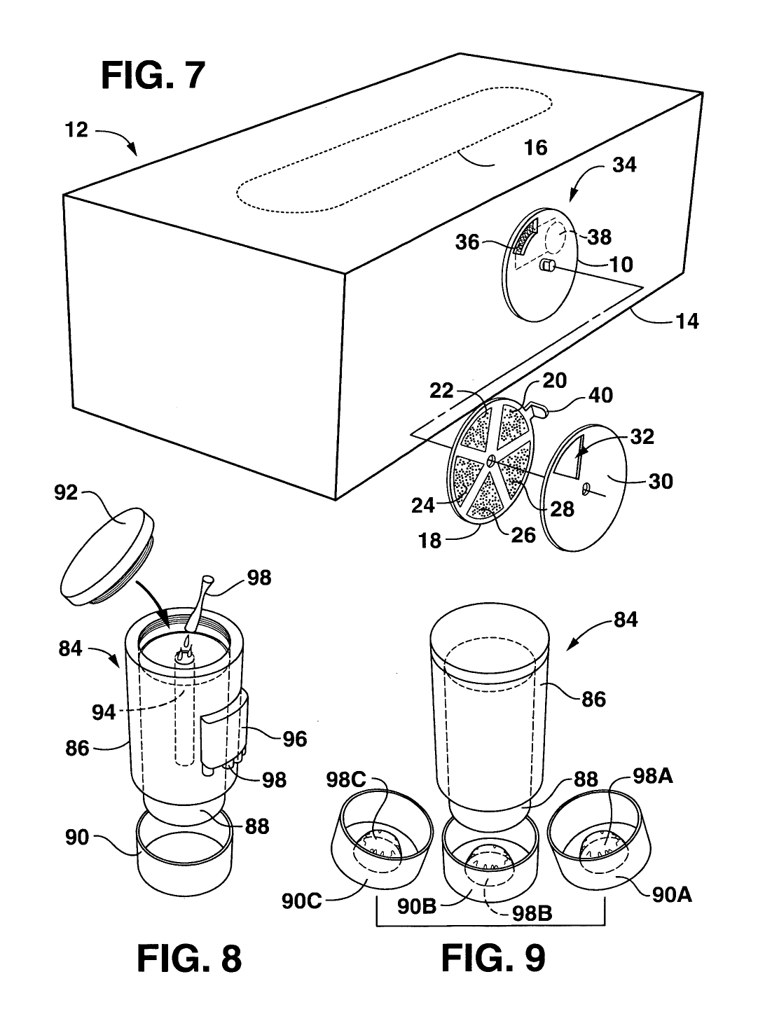

Referring to FIG. 7, another embodiment of a consumable product in combination with an aroma delivery device is shown. In FIG. 7, like reference numerals have been used to indicate the same or similar elements.

As shown in FIG. 7, a consumable product 12, such as a box of facial tissues, is illustrated in combination with an aroma delivery device 10. Similar to FIG. 1, the aroma delivery device 10 includes a substrate 18 containing a plurality of aroma elements 20, 22, 24, 26 and 28. An outer cover 30 is placed over the substrate 18. The outer cover 30 includes an opening 32 for allowing a user to select one of the aroma elements. In particular, the substrate 18 includes a tab 40 that may be used to move the substrate with relation to the opening 32.

In the embodiment illustrated in FIG. 7, the aroma delivery device 10 further includes a heating device 34 for heating the user-selected aroma element. By providing heat to the aroma element, greater amounts of scent may be released through the opening 32.

In one embodiment, the heating device 34 includes a heating element 36 placed in combination with a power source 38. The power source 38 may comprise a thin, flexible battery, such as a printed battery commercially available from PowerPaper or a fuel cell, such as a direct methanol micro-fuel cell. The heating element 36 may comprise a coil as shown in FIG. 7 or may be formed from polymer-based electronics or electrically conductive printed inks that may be applied to a flexible substrate such as a film, nonwoven web or paper web. The heating device 34 may include some type of switch device that closes the circuit between the power source 38 and the heating element 36 for activating the heating device.

In the embodiments shown in FIGS. 1 and 7, the tissue dispenser 14 can include various designs and graphics that match the aroma elements contained on the aroma delivery device 10. For example, if the aroma elements on the aroma delivery device 10 include flower fragrances, the dispenser 14 may include pictures or graphics of flowers to help reinforce the scent that is being released. In addition to deigns, colors can also be used to match with the aroma element. For example, if the aroma delivery device includes citrus or fruit scents, the tissue dispenser may include bright colors that complement the user-selected scent.

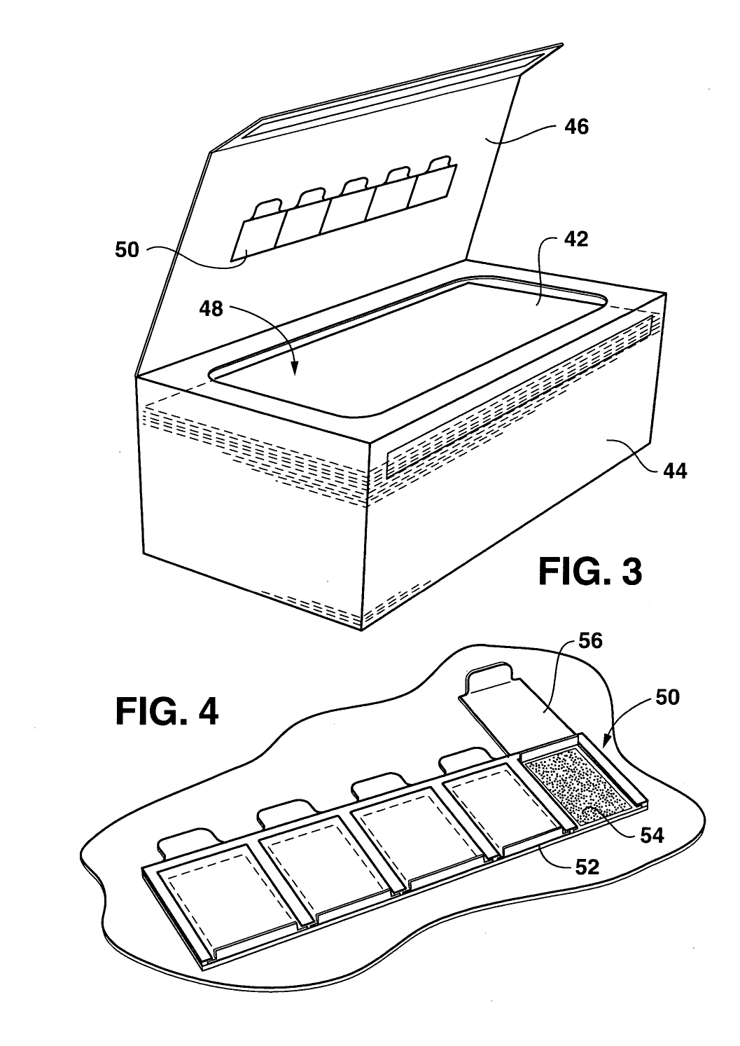

Referring to FIG. 3, another embodiment of a consumable product in conjunction with an aroma delivery device is illustrated. In this embodiment, the consumable product comprises a plurality of pre-moistened wipes 42 contained within a dispenser 44. In this embodiment, the dispenser 44 includes a lid 46 that covers an opening 48 through which the pre-moistened wipes are dispensed.

As shown, an aroma delivery device 50 is mounted to the inside surface of the lid 46. In this manner, a scent can be released by the aroma delivery device for providing a scent directly to the pre-moistened wipes 42 or for providing a scent when the dispenser 44 is opened.

The aroma delivery device 50 is shown in greater detail in FIG. 4. In this embodiment, the aroma delivery device 50 includes a substrate 52 that contains a plurality of aroma elements, such as aroma element 54. Specifically, in this embodiment, the substrate 52 includes six different aroma elements. Each of the aroma elements are covered by a corresponding cover, such as cover 56. As shown, cover 56 is slideably mounted within the aroma delivery device 50 for covering or exposing the underlying aroma element 54. In this manner, a user can open one or more of the covers 56 for exposing the underlying aroma element.

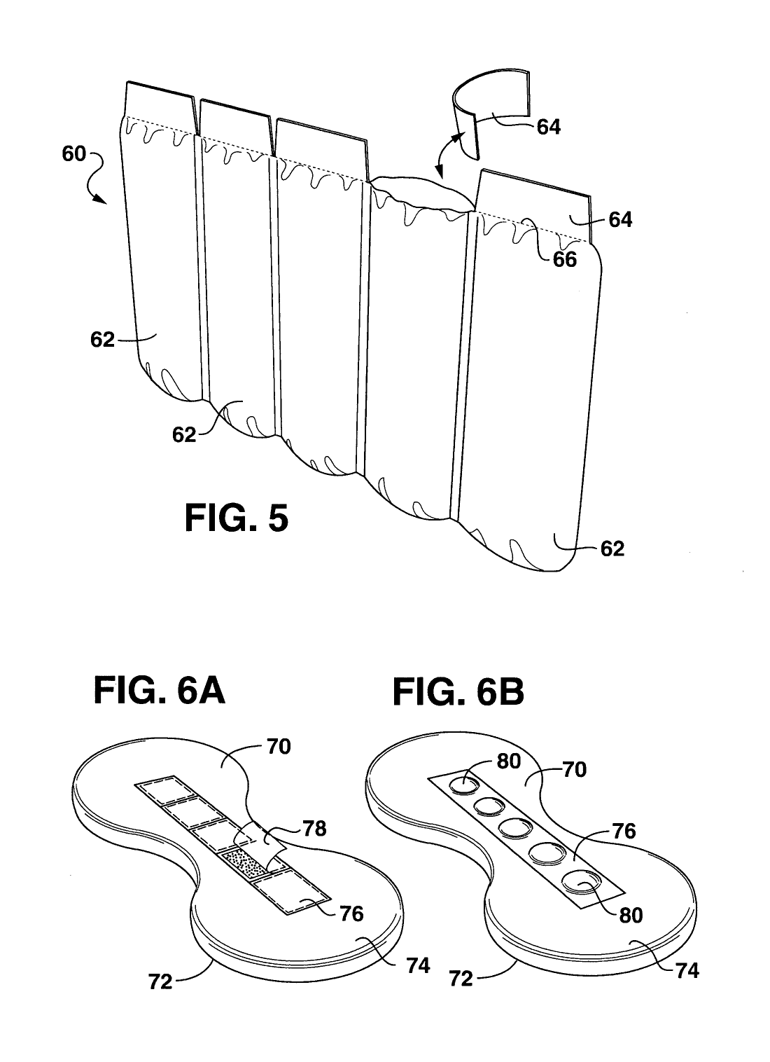

In the embodiments illustrated in FIGS. 1 and 7, the aroma delivery device is generally intended to provide a scent to the environment in which the consumable product is to be used. In other embodiments, however, it may be desirable to include an aroma delivery device to provide a scent directly to the consumable product itself. For example, referring to FIG. 5, another embodiment of an aroma delivery device 60 is shown. In this embodiment, the aroma delivery 60 includes a plurality of containers 62 that are each configured to hold a corresponding aroma element. For example, in the embodiment illustrated in FIG. 5, the containers 62 are made from a flexible film material. If desired, all of the containers can be attached together as shown in FIG. 5 or may be separate. Each container further includes a tab portion 64 that is separated from the body of the container by a frangible seal 66. In this manner, a user can open one or more of the containers by pulling on the tab portion 64.

The aroma element included within the container may comprise a liquid composition or a solid composition. Once the frangible seal 66 is pulled apart to open the container, the aroma composition may then be applied to the appropriate consumable product. The consumable product, for instance, may comprise a stack of facial tissues as shown in FIG. 1 or a stack of pre-moistened wipes as shown in FIG. 3. In still other embodiments, the consumable products may comprise a roll of paper towels, bath tissue, or any other suitable product. For instance, in one embodiment, the aroma delivery device 60 as shown in FIG. 5 may be used in conjunction with a diaper or feminine care product for applying a user-selected scent to the product.

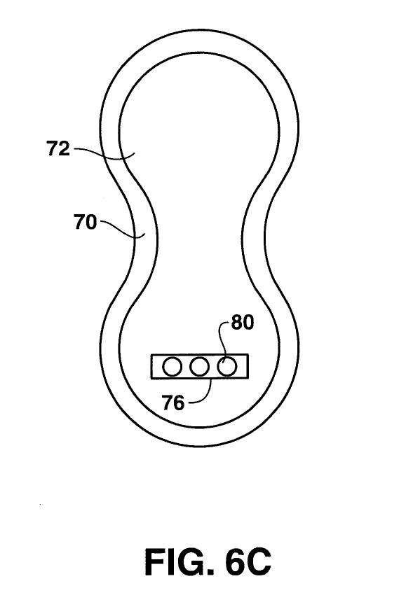

Referring to FIGS. 6A and 6B, still another embodiment of a consumable product in combination with aroma delivery devices is illustrated. In the embodiments shown in FIGS. 6A and 6B, the consumable product comprises a feminine hygiene product 70, such as an absorbent sanitary pad. The feminine hygiene product 70 includes a body side 72 and a garment side 74 when worn. On the garment side 74 is positioned an aroma delivery device 76 that contains a plurality of user-selectable aroma elements.

For instance, as shown in FIG. 6A, the aroma delivery device 76 comprises a strip of aroma elements that are each covered by a peel away film 78. Each aroma element can carry a different scent. The user of the product can then select a particular scent by peeling away the film 78.

In the embodiment illustrated in FIG. 6A, the aroma delivery device 76 is depicted as a strip of aroma elements. It should be understood, however, that the aroma elements may be arranged on the product in any suitable manner. For example, in one embodiment, the aroma elements may be combined together and incorporated into one or more design elements that improve the aesthetics of the product.

In the embodiment shown in FIG. 6B, on the other hand, the aroma delivery device contains a plurality of blister packs 80. Each blister pack 80 may contain an aroma composition containing a different scent. In order to activate one of the aroma elements, the blister pack can be pressed on by a user to rupture the film covering and thus exposing the aroma composition.

In one embodiment, the aroma delivery device may include a plurality of blister packs that all contain the same scent. In this embodiment, the intensity of the scent may be controlled by rupturing a controlled number of blister packs. For instance, in one embodiment, the aroma delivery device may include three blister packs all containing the same scent. If the consumer wants a strong scent, all three blister packs may be ruptured. If a weak scent is desired, however, only a single blister pack may be ruptured.

Referring to FIG. 6C, still another embodiment of a feminine hygiene product 70 is shown. Like reference numerals have been used to indicate similar elements. As shown, the feminine hygiene product 70 includes a body side 72. In the embodiment shown in FIGS. 6A and 6B, the aroma delivery device was positioned on the garment side of the article. In FIG. 6C, however, an aroma delivery device 76 is positioned on the body side 72 of the article 70. In this embodiment, the aroma delivery device 76 comprises a plurality of blister packs 80. It should be understood, that any suitable aroma delivery device as described above or below may be incorporated into the product.

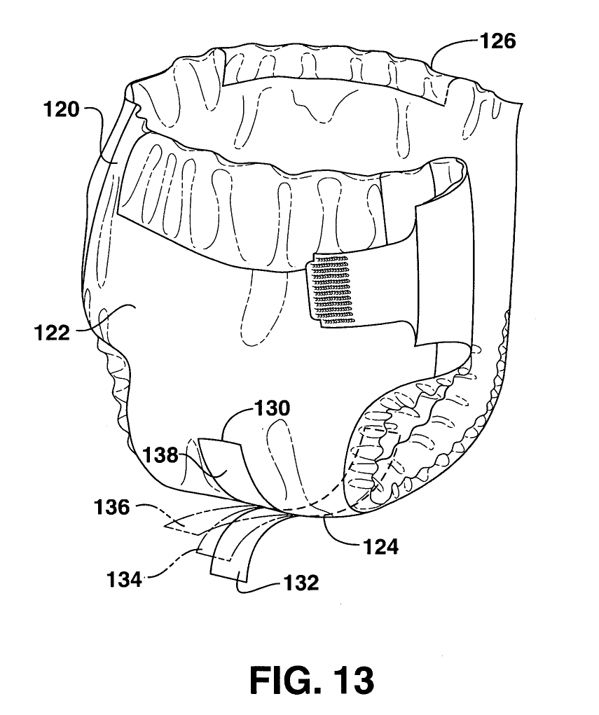

Referring to FIG. 13, another embodiment of a consumable product in combination with an aroma delivery device is shown. In this embodiment, the consumable product comprises an incontinence product, such as a diaper 120. The diaper 120 includes a back portion 122, a crotch portion 124, and a front portion 126. On the crotch portion 124 is positioned an aroma delivery device 130.

In this embodiment, the aroma delivery device 130 includes a plurality of peelable substrates 132, 134, 136 and 138. Not shown, a top layer may be positioned over the peelable substrate 132 during packaging. In this embodiment, all of the peelable substrates comprise aroma elements. In particular, the peelable substrates 132, 134, 136 and 138 all contain a selected aroma producing composition for emitting a selected aroma. In this manner, a user can peel away the substrates until the user reaches a desired fragrance or aroma.

Each of the peelable substrates 132, 134, 136 and 138 can comprise any suitable material capable of receiving an aroma producing composition. For instance, the substrates can be made from paper, a polymeric material, or a combination of both. In one embodiment, for instance, the substrates may comprise a paper that is coated on one side with an adhesive material mixed with the selected aroma producing composition and on the other side with a release material, such as a wax or silicone composition. The adhesive material may comprise, for instance, a pressure sensitive adhesive, that is configured to releasably hold an adjacent substrate.

As described above, in one embodiment, the adhesive composition may be combined with an aroma producing composition. The aroma producing composition may comprise a plurality of microcapsules that are configured to be ruptured when a top layer is removed from the substrate. Rupturable capsules, for instance, are disclosed in U.S. Pat. No. 4,186,743 which is incorporated herein by reference. The aroma producing composition may contain, for instance, a fragrance, a perfume, a deodorant material, and mixtures thereof.

In the embodiment shown in FIG. 13, the aroma delivery device 130 is positioned at the crotch portion 124 of the diaper 120. It should be understood, however, that the aroma delivery device 130 can be placed at any suitable location. As can be appreciated, the aroma delivery device 130 can also be attached to various other products and to the packaging in which the products are shipped or dispensed.

For example, in other embodiments, the aroma delivery device 130 as shown in FIG. 13 may be attached to an adult incontinence product, a feminine hygiene product, a training pant, or the like. Alternatively, the aroma delivery device 130 can be attached to a dispenser for wiper products, such as a facial tissue dispenser, a bath tissue dispenser, or a dispenser for premoistened wipes.

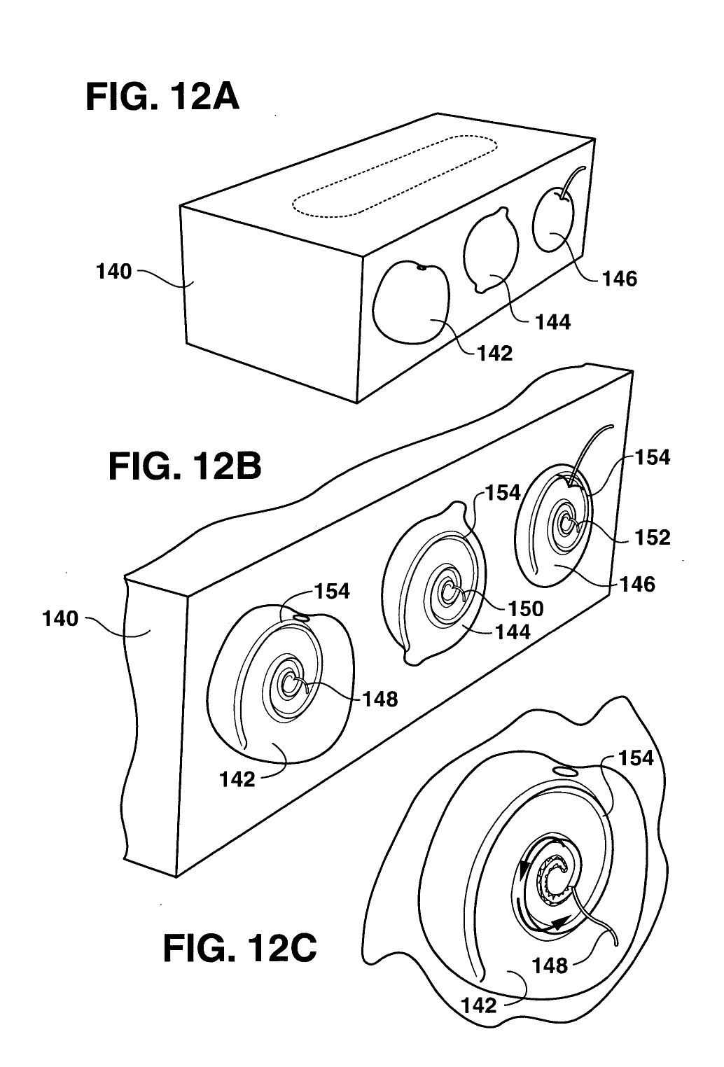

Referring to FIGS. 12A, 12B and 12C, still another embodiment of a consumable product in combination with an aroma delivery device is illustrated. In FIGS. 12A, 12B and 12C, the consumable product comprises a dispenser 140 containing facial tissues that are to be removed from the dispenser one at a time. As shown in FIG. 12A, the facial tissue dispenser 140 includes a plurality of design elements 142, 144 and 146. For example, in this embodiment, design element 142 comprises a picture of an orange, design element 144 comprises a picture of a lemon, while design element 146 comprises a picture of a cherry.

Referring to FIG. 12B, each of the design elements 142, 144 and 146 are in operative association with an aroma delivery device. In particular, in this embodiment, the aroma delivery device comprises string members 148, 150 and 152. In accordance with the present disclosure, the string members 148, 150 and 152 each contain an aroma producing composition. The aroma producing composition, for instance, may be coated on the string members or impregnated into the string members. Further, the string members 148, 150 and 152 are enclosed by a coating composition 154. The coating composition 154 encloses the string members and prevents any aromas from being released. As the string members 148, 150 and 152 are pulled, however, the coating composition forms breaches exposing the string member and releasing the selected aroma. In this manner, a user can select a particular string member for releasing a particular aroma and can pull the string member a desired length for releasing a desired amount of the aroma.

In general, the coating composition can comprise any suitable friable material capable of releasing the aroma producing composition when the string members are pulled. For instance, the coating composition 154 may be made from any suitable resin, polymeric material, or adhesive material. The coating composition 154 may serve a dual purpose for enclosing the string members while also adhering the string members to the dispenser 140. Alternatively, the string members may be enclosed within the coating composition and the coating composition may thereafter be adhered to the dispenser.

In one particular embodiment, the coating composition comprises a brittle material, such as a sugar coating, a starch coating, or a mixture of a sugar and a starch.

As shown in FIG. 12C, the string member is intended to be pulled incrementally over a period of time. In one embodiment, the string member may be in a spiral arrangement for minimizing the amount of space the string member occupies on the dispenser and for even improving the aesthetics of the dispenser 140.

As shown in FIG. 12B, in one embodiment, the design elements on the facial tissue dispenser 140 can coordinate with the string members. For instance, the string members may be incorporated into the design elements. For example, the string member 148 may have an orange color within the design element 142, while the string member 150 may have a yellow color within the design element 144. In addition, each string member may emit an odor that matches the design element. For example, the string member 148 may emit an orange scent, the string member 150 may emit a lemon scent, and the string member 152 may emit a cherry scent.

As can be appreciated, the design elements appearing on the dispenser can vary dramatically depending upon the particular application and the desired result. For instance, instead of different fruits as shown in the figures, the dispenser 140 may include pictures of flowers and various other scenes.

In the embodiments shown in FIGS. 12A, 12B and 12C, the string members 148, 150 and 152 are shown adhered to the side of a facial tissue dispenser 140. It should be understood, however, that the string members can be attached to any suitable consumable product or to the packaging for the product. In other embodiments, for instance, the string members may be attached directly to incontinence products, such as diapers, pull-ups, feminine hygiene products, or adult incontinence products.

In still other embodiments of the present disclosure, an aroma delivery device may be used in combination with other types of personal hygiene products. For instance, as shown in FIGS. 8, 9 and 10, an aroma delivery device may be used in combination with a deodorant or antiperspirant product. For example, referring to FIG. 8, a deodorant or antiperspirant product 84 is shown. The deodorant or antiperspirant product 84 includes an applicator 86 that contains an antiperspirant or deodorant composition 88. In this embodiment, the deodorant or antiperspirant composition 88 is a solid material that is intended to be transferred to the skin of a user. For instance, the composition 88 may comprise aluminum chlorohydrate. In order to protect the composition 88 during storage, the deodorant or antiperspirant product 84 includes a cap 90.

In accordance with the present disclosure, the deodorant or antiperspirant product 84 further includes a bottom 92 that may be removed from the applicator 86. When the bottom 92 is removed from the applicator 86, the deodorant or antiperspirant composition 88 becomes exposed. As shown, formed into the composition 88 is at least one hollow portion 94.

The deodorant or antiperspirant product 84 further includes an aroma delivery device 96 that, in this embodiment, is attached to the side of the applicator 86. The aroma delivery device in this embodiment includes a plurality of aroma elements 98. The aroma elements 98 comprise a collapsible container containing a liquid aroma composition. In accordance with the present disclosure, a user may select one of the aroma elements 98 for application to the deodorant or antiperspirant composition 88. More particularly, each of the aroma elements 98 may contain a different scent. A user can then select one of the aroma elements 98 for providing the deodorant or antiperspirant composition 88 with a particular scent. As shown, an aroma element 98 may be squeezed together causing the container to rupture and the aroma composition to be applied to the hollow portion 94 of the deodorant or antiperspirant composition 88.

Referring to FIG. 9, another embodiment of a deodorant or antiperspirant product 84 is shown. Like reference numerals have been used to indicate similar or like elements. As shown, the deodorant or antiperspirant product 84 includes an applicator 86 containing a deodorant or antiperspirant composition 88.

In this embodiment, the deodorant or antiperspirant product 84 may be sold with three different caps 90A, 90B and 90C that are intended to cover the exposed portion of the deodorant or antiperspirant composition 88. Each of the caps can include a corresponding aroma element 98A, 98B and 98C that are intended to deliver a scent to the deodorant or antiperspirant composition 88. In this embodiment, the aroma element 98A, 98B and 98C can comprise a solid material or a liquid material contained within a rupturable container. Each aroma element may carry a different scent that can be user-selected. Specifically, a user can provide the deodorant or antiperspirant composition 88 with a particular scent by choosing a different cap 90A, 90B or 90C. The caps containing the corresponding aroma elements may be configured for a one time use to deliver scent to the deodorant or antiperspirant composition or may be configured to continually provide scent to the deodorant or antiperspirant composition 88 as the composition is consumed by the consumer.

Alternatively, one cap with two or more blister packs filled with different fragrances may be used, wherein the user can rupture a blister pack to allow a fragrance to diffused from the cap into the solid antiperspirant while the cap is placed over the antiperspirant (e.g., overnight).

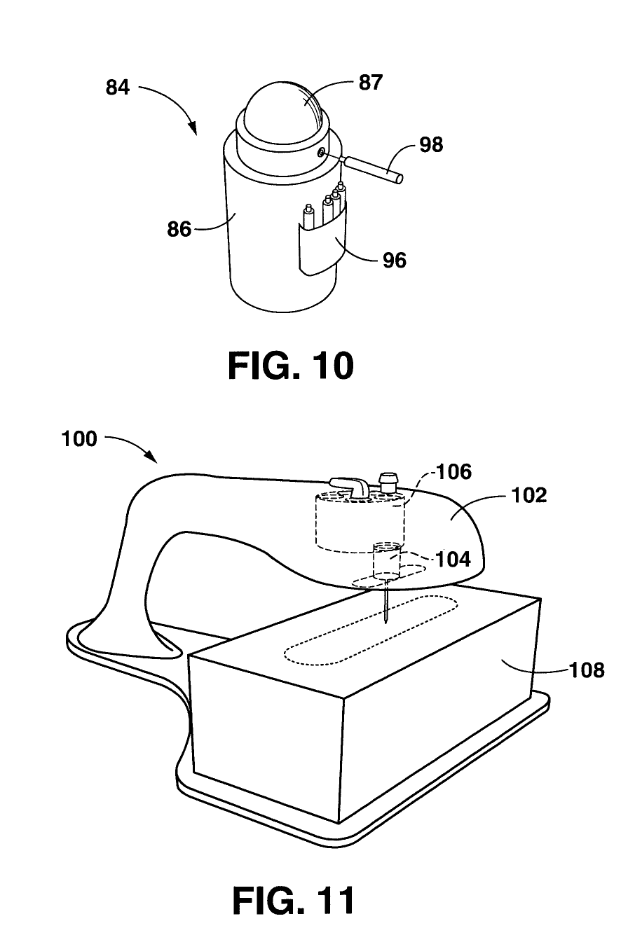

Referring to FIG. 10, still another embodiment of a deodorant or antiperspirant product 84 is shown. Again, like reference numerals have been used to indicate similar elements. As shown, the deodorant or antiperspirant product 84 includes an applicator 86 containing a deodorant or antiperspirant composition. In this embodiment, the applicator 86 includes a rotatable ball 87 for dispensing a liquid composition.

In accordance with the present disclosure, the deodorant or antiperspirant product 84 further includes an aroma delivery device 96 containing a plurality of aroma elements 98. The aroma elements comprise a container containing a scented liquid composition. As shown in FIG. 10, a user may select one of the aroma elements 98 for injection into the applicator 86. In this manner, a particular scent may be applied to the deodorant or antiperspirant composition contained within the applicator.

An example of a mechanical system in which fragrant liquids from two or more sources can be combined with a microprocessor controlling the relative amounts of the liquids being delivered is described in U.S. Pat. No. 6,189,810, “Method for Aerosol Spraying Liquid Perfume Products,” issued Feb. 20, 2001 to Nerushai et al., herein incorporated by reference. The control system of Nerushai et al. is believed to be readily adaptable to an injection system rather than a spray system, if desired, although for some applications within the scope of the present invention, delivery of the customized fragrance can also be achieved by spraying a material into or onto a product or its container. Another system for delivering one or more fragrances from a plurality of fragrance sources is described in U.S. Pat. No. 6,464,110, “Perfume Dispensing Implement,” issued Oct. 15, 2002 to Yamada, herein incorporated by reference, which can be adapted for the purposes of the present invention.

In the embodiments described above, an aroma delivery device including a plurality of user-selectable aroma elements is packaged with a consumable product, such as a tissue product or a personal hygiene product. In still another embodiments of the present disclosure, an aroma delivery device may be designed that is intended to provide a user-selected scent to a consumable product at the point purchase of the consumable product.

For example, referring to FIG. 11, one embodiment of an aroma delivery device 100 that maybe used to provide a scent or fragrance to a product at the point of purchase is illustrated. The aroma delivery device 100 includes an aroma injector head 102. The aroma injector head 102 may be configured to not only recognize a product loaded on the aroma delivery device 100 but also to inject an aroma composition into the product. For instance, as shown, the injector head 102 includes an injector 104 in communication with a plurality of aroma elements 106.

In order to use the aroma delivery device 100 as shown in FIG. 11, a consumer can first load a consumable product into the device, such as a box of facial tissues 108. In one embodiment, the aroma delivery device 100 can first scan the product to identify the product and to ensure that a correct product has been loaded into the device and that the product has been loaded correctly. Identification of the product can be done through a camera or photo cell that can scan an identifying label such as a barcode on the object. Other means for identifying the object can include the use of a radio frequency identification reader (RFID reader) that reads a unique serial code or other identifier such as an electronic product code emitted by an RFID tag on or in the product. With an identified product in place and with the suitability of the product for fragrance addition having been verified, an aroma element or fragrance can then be delivered to the product. Delivery can be by injection delivered by a lancet 104 whereby a high-pressure pulsed pneumatic delivery of an aerosol can penetrate the packaging material.

If desired, the aroma delivery device 100 can include a computer interface that can be user-operated for selecting a particular aroma element or fragrance. As shown in FIG. 11, the aroma delivery device 100 can include a carousel of aroma elements 106. The aroma delivery device 100 may be configured to inject a composition from one of the aroma elements based upon user input. Further, the aroma delivery device 100 may be configured to combine different aroma elements together to produce even further scents or fragrances. For instance, a vanilla fragrance may be combined with a cherry fragrance to produce a new fragrance. The aroma delivery device may be configured to hold a few vials of composition or many vials, such as 40 or greater. Once the user has selected a particular fragrance, the corresponding vial can be positioned into an appropriate location internally to allow the contents to be delivery externally.

In one embodiment, the user can select or create a particular recipe to create a desired fragrance and then store the recipe in a database associated with the aroma delivery device 100. The created recipe may be shared with others if desired by the user. For example, one or more recipes may be associated with a particular user in a database or may be stored on a medium associated with the user such as on a magnetic card or data disc that may be inserted into the device. When the user makes a purchase, the user can readily access the stored recipe from a database or from a machine readable medium associated with the user, allowing the user to select a desired fragrance from a list of favorites, or allowing the user to select a new fragrance.

In one embodiment, the aroma delivery device 100 can also be equipped to generate a particular fragrance for preview by the consumer prior to being injected into the product.

A customized aroma applied to a product by a delivery device 100 can be selected by a user in a wide variety of ways. The user may select an aroma from a display or collection of test strips, each identified with codes that can be entered into a user interface. A code such as “349” may indicate, for example, a particular pre-mixed perfume or may indicate that two or more ingredients associated with the delivery device should be combined in particular ratios to provide the customized aroma. Codes or recipes for desired fragrances capable of being delivered from the aroma delivery device can be manually entered by the user, or may be electronically entered based on user preferences previously entered into a database. For example, once a user has determined what custom odors are preferred for particular products, the user can be electronically identified by reading a loyalty card that is swiped or by reading an RFID tag associated with the users ID that is read by an RFID scanner associated with the aroma delivery device, or by any other known means to identify the user. Once the user is identified, the customized aroma preferences for the reader can be read from a database. Alternatively, the aroma preferences can be read directly from a loyalty card, an RFID tag, a PDA, a machine-readable card or paper strip, etc. The aroma preferences for the user can identify a single aroma to be applied, or can comprise a list linking various preferred aromas with various products, such as aroma “632” for KLEENEX® facial tissue, and aroma “3102” with HUGGIES® wet wipes. The selected product can then be placed in the delivery device, wherein it may be automatically identified by reading a bar code or RFID tag associated with the product or other automatic identification system, or wherein the user can provide input to identify the product (e.g., speaking the product identity, selecting the product type from a menu of items in a graphical user interface, typing in a code or product name, pressing a button specific to a product category, etc.). Once the desired odor for the product has been identified, it can be delivered. The amount delivered or the aroma intensity can be determined by values entered in the user preferences, or may be customized by the user at the time of application (e.g., with a dial, knob, slider, computer input means, etc. to identify the intensity desired). The appropriate amount of the desired aroma is then delivered (e.g., a needle may pierce the product to apply the aroma, or a spray may be applied to or through a wall of the product package) and the product is removed.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed:

1. A packaged product comprising:
a consumable product;
packaging surrounding the consumable product; and
an aroma delivery device contained within the packaging, the aroma delivery device comprising a plurality of user-selectable aroma elements, each aroma element possessing a different scent, and wherein the aroma delivery device is configured such that a user of the consumable product can select and activate at least one of the aroma elements for releasing a scent into the consumable product or into an environment where the consumable product is located.

2. A packaged product as defined in claim 1, wherein the aroma delivery device comprises a substrate upon which the aroma elements are located, the aroma delivery device further including a cover positioned over the substrate, the cover being movable with respect to the substrate for selectively exposing one or more of the aroma elements.

3. A packaged product as defined in claim 2, wherein the substrate is in the shape of a disk and the cover defines an opening, the cover being movable with respect to the disk for exposing one of the aroma elements through the opening.

4. A packaged product as defined in claim 1, wherein the aroma delivery device includes at least three aroma elements.

5. A packaged product as defined in claim 1, wherein the consumable product comprises facial tissues and the packaging comprises a facial tissue dispenser, the aroma delivery device being attached to an outside surface of the facial tissue dispenser.

6. A packaged product as defined in claim 1, wherein the consumable product comprises pre-moistened wipes and the packaging comprises a dispenser, the aroma delivery device being attached to an outside surface of the dispenser.

7. A packaged product as defined in claim 1, wherein the consumable product comprises pre-moistened wipes and the packaging comprises a dispenser, the aroma delivery device being attached to an inside surface of the dispenser.

8. A packaged product as defined in claim 1, wherein the aroma delivery device comprises a substrate upon which the aroma elements are located, each of the aroma elements being individually sealed by an odor-pervious covering that can be removed by the user to expose the underlying aroma element.

9. A packaged product as defined in claim 1, wherein the aroma elements are contained within sealed pouches, each sealed pouch including a frangible seal.

10. A packaged product as defined in claim 2, wherein the aroma delivery device further comprises a mounting device for mounting the aroma delivery device to the packaging.

11. A packaged product as defined in claim 1, wherein the consumable product comprises a feminine care product, an adult incontinence product, a training pant, or a diaper.

12. A packaged product as defined in claim 1, wherein the aroma elements comprise microcapsules containing a fragrance, a wax mixed with a fragrance, or activated carbon containing a fragrance.

13. A packaged product as defined in claim 1, wherein the aroma delivery device further comprises a heating device in operative association with the user-selectable aroma elements for heating the aroma elements and releasing a scent.

14. A packaged product as defined in claim 1, wherein the consumable product comprises an antiperspirant or deodorant product, the antiperspirant or deodorant product containing an antiperspirant or deodorant composition configured to be transferred to a user, the aroma delivery device for applying an aroma element to the deodorant or antiperspirant composition.

15. A packaged product as defined in claim 14, wherein the deodorant or antiperspirant composition comprises a solid, the composition defining a hollow body for receiving at least one of the aroma elements.

16. A packaged product as defined in claim 1, wherein the aroma elements comprise string members, each string member containing a selected aroma producing composition for emitting a selected aroma, the string members being attached to the packaging of the consumable product or to the product itself and being enclosed by a coating composition that prevents the selected aroma from being released, the coating composition being configured to form breaches and expose the string member as the string member is pulled incrementally away from the packaging or from the product for releasing the selected aroma.

17. A packaged product as defined in claim 16, wherein each string member is impregnated with the aroma producing composition.

18. A packaged product as defined in claim 16, wherein the coating composition comprises a resin.

19. A packaged product as defined in claim 16, wherein the coating composition comprises a sugar, a starch, or mixtures thereof.

20. A packaged product as defined in claim 16, wherein at least one string member is attached to the packaging of the consumable product and wherein the packaging includes design elements that coordinate with the selected aroma of the string member.

21. A packaged product as defined in claim 20, wherein the design element comprises a flower design or a fruit design and wherein the selected aroma of the string member is an aroma of the flower or the fruit.

22. A packaged product as defined in claim 21, wherein the string member is integrated into the design element.

23. A packaged product as defined in claim 16, wherein the string member is attached to the packaging or to the consumable product in a spiral design.

24. A packaged product as defined in claim 1, wherein the aroma elements of the aroma delivery device comprise peelable substrates stacked together, each peelable substrate containing an aroma producing composition for emitting a selected aroma, the peelable substrate being configured to be peeled away by a user for exposing a selected aroma.

25. A packaged product as defined in claim 24, wherein the aroma delivery device is attached to the packaging of the consumable product.

26. A packaged product as defined in claim 24, wherein the aroma delivery device is attached to the consumable product itself.

27. A packaged product as defined in claim 26, wherein the consumable product comprises a feminine care product, an adult incontinence product, a training pant, or a diaper.

28. A packaged product as defined in claim 24, wherein the aroma producing composition contained in the substrate comprises microcapsules that are ruptured when the aroma element is exposed.

29. A packaged product as defined in claim 24, wherein the aroma elements comprise a substrate coated with an adhesive composition, the adhesive composition containing the aroma producing composition.

30. A process for providing a scent to a consumable product comprising:
selecting a consumable product in a retail store; and
at the point of purchase, applying a user-selected aroma composition to the consumable product.

31. A process as defined in claim 30, wherein the aroma composition is applied to the consumable product by an aroma delivery device located within the retail store.

32. A process as defined in claim 31, wherein the aroma delivery device is configured to scan the consumable product to ensure that a correct product category has been loaded into the aroma delivery device.

33. A process as defined in claim 31, wherein the aroma delivery device is capable of dispensing at least three different aroma compositions.

34. A process as defined in claim 31, wherein the aroma delivery device injects or sprays the aroma composition into the consumable product.

35. A process as defined in claim 34, wherein the consumable product comprises a facial tissue or a bath tissue.

36. A deodorant or antiperspirant product comprising:
an applicator;
a deodorant or antiperspirant composition contained in the applicator, the deodorant or antiperspirant composition being configured to be transferred to a user; and
an aroma delivery device comprising a plurality of user-selectable aroma elements and wherein a user can select one of the aroma elements for application to the deodorant or antiperspirant composition for providing the deodorant or antiperspirant composition with a user-selected scent.

37. A deodorant or antiperspirant product as defined in claim 36, wherein the deodorant or antiperspirant composition comprises a solid material contained within the applicator, the deodorant or antiperspirant composition defining an internal hollow area for receiving one of the aroma elements.

38. A deodorant or antiperspirant product as defined in claim 36, further comprising a plurality of caps that fit over the applicator for contact with the deodorant or antiperspirant composition, each cap containing a different aroma element for application to the deodorant or antiperspirant composition.

39. A deodorant or antiperspirant product as defined in claim 36, wherein the deodorant or antiperspirant composition comprises a liquid and wherein the user-selected aroma element is injected into the deodorant or antiperspirant composition.

40. A method for delivering a customized aroma to a product comprising:
inputting a customer identifiable indicia into an aroma delivery device;
inputting into the aroma delivery device an aroma selection;
positioning the product in the aroma delivery device; and
applying a user selected aroma to the product.

41. A method as defined in claim 40, further comprising the step of inputting the type of product into the aroma delivery device prior to applying the user selected aroma to the product.

42. A method as defined in claim 40, wherein the aroma delivery device stores past selected aromas chosen by a particular customer so that the customer, once identified, can access the past selections.

43. A method as defined in claim 40, wherein the customer identifiable indicia comprises a magnetic card or a RFID device.

44. A method as defined in claim 40, wherein the selected aroma comprises a mixture of different aroma producing compositions.

45. A method as defined in claim 42, wherein the aroma delivery device stores past selected aromas and categorizes the aromas by products.

46. A method as defined in claim 40, further comprising the step of inputting into the aroma delivery device an intensity for the selected aroma.
